(19) United States
(12) Patent Application Publication
(10) Pub. No.: US 2019/0022838 A1
(43) Pub. Date: Jan. 24, 2019

(54) BEARING RACE AND SEAL DRIVER HANDLE

(71) Applicant: SNAP-ON INCORPORATED, KENOSHA, WI (US)

(72) Inventors: Allen M. Hutchison, Beach Park, IL (US); Jonathan I. Andersen, Racine, WI (US)

(73) Assignee: SNAP-ON INCORPORATED, KENOSHA, WI (US)

(21) Appl. No.: 15/655,435

(22) Filed: Jul. 20, 2017

(51) Int. Cl. B25B 27/06; B25B 27/00; B25G 1/10

(52) U.S. Cl. CPC B25B 27/06; B25G 1/102; B25B 27/0028

(57) ABSTRACT

Disclosed is a bearing race and seal driving tool with a grip that is molded to receive a user's hand while having a cap that can be struck by a hammer during use. The handle can include a ball detent and the driver can include a groove or other indent that detainably engages with the ball for quick assembly. The tool therefore provides for quick assembly with fewer components than prior art tools and further allows the user to grip the tool while including a corresponding cap that can be struck to apply the seal or bearing race during use.

### TECHNICAL FIELD OF THE INVENTION

The present invention relates generally to bearing race and seal tool sets. More particularly, the present invention relates to a handle and driver combination for a bearing race and seal driver set capable of being removably coupled together.

### BACKGROUND OF THE INVENTION

Bearings, also known as bearing races, are used in many ball bearing applications to allow relative movement between two objects. Bearing races include outer and inner races with ball bearings located in between. The ball bearings allow the outer and inner races to move relative to each other, typically in a circular motion, with reduced friction. Also, seals are often used with bearing races and ball bearings to seal the ball bearings and races to reduce contamination and maintain lubricants, such as grease. However, bearing races and seals require periodic maintenance and/or replacement.

Bearing race and seal driver sets allow a user to install bearing races or seals with a simple hand tool. For example, a prior art bearing race and seal driver set is depicted in FIGS. 6 and 7. A prior art tool 600 includes a handle 605, a driver 610, and a fastener 615. The handle 605 inserts into an opening of the driver 610 and is fastened to the driver 610 with the fastener 615. The driver 610 can then be used to install a bearing race or seal into the necessary groove or opening.

Conventional bearing race and seal drivers include three separate components—the handle 605, driver 610, and fastener 615—which must be coupled together to fully assemble the tool 600. These separate components may become lost during use or while in storage. The user must also connect the fastener 615 to the handle 605 using external threads of the fastener 615 and internal threads of the handle 605, or vice versa. This process requires time and sometimes requires a separate fastening tool to complete assembly. The tool can also include a handle 605 that is difficult to grip, or that fails when struck by a hammer or other tool during use.

### SUMMARY OF THE INVENTION

The present invention broadly comprises a bearing race and seal driving tool having a molded grip that is adapted to receive a user's hand while a cap can be struck by a hammer during use. The driver can include a groove or other indent that receives a ball detent of the handle for quick assembly, and to detain the driver on the handle. One benefit of the present invention is that it eliminates the additional component of a fastener, allows quick and easy assembly, and allows the user to grip the tool while including a corresponding cap that can be struck to install the seal or bearing race.

In particular, in an embodiment, the present invention broadly comprises a tool including a handle having a grip, a rod extending from the grip, a drive extending from the rod, and a ball disposed within the drive and biased outward relative to the longitudinal axis of the drive. The tool further includes a driver disk including a body, an opening defined within the body, and a groove defined within the opening that engages the ball to detainably or releasably couple the handle to the driver disk.

In another embodiment, the present invention broadly comprises a tool including a grip composed of a grip material, a rod extending from the grip and having a rod cross-sectional area, a cap disposed proximate the handle and composed of a cap material, wherein the cap material has a higher impact toughness compared to the grip material, a drive extending from the rod and that has a drive cross-sectional area less than the rod cross-sectional area, a chamfer disposed at an axial end of the drive, and a ball disposed within the drive and biased outward relative to the longitudinal axis of the drive. The tool may further include a driver disk having a body, a rim extending circumferentially from the body, an opening defined within the body, and a groove defined within the opening to engage with the ball to detainably or releasably couple the handle to the driver disk.

In yet another embodiment, the present invention broadly comprises a method of assembling a tool including providing a handle having a grip, a rod extending from the grip, a drive extending from the rod, and a ball disposed within the drive and biased outward relative to the longitudinal axis of the drive, providing a driver disk including a body, an opening defined within the body, and a groove defined within the opening, and releasably coupling the handle to the driver disk by inserting the drive into the opening, depressing the ball against a bias of the ball, and allowing the ball to engage the groove to detainably or releasably couple the handle to the driver disk.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a bearing race and seal driver set in a disassembled state according to at least some embodiments of the present invention.

FIG. 2 is a partial enlarged perspective view of a bearing race and seal driver set handle according to at least some embodiments of the present invention.

FIG. 3 is a side cross sectional view of a driver disk, as cut along line 3-3 in FIG. 1, according to at least some embodiments of the present invention.

FIG. 4 is a partial enlarged perspective view of a bearing race and seal driver in an assembled condition, with the driver in a first position, according to at least some embodiments of the present invention.

FIG. 5 is a partial enlarged perspective view of a bearing race and seal driver set in an assembled condition, with the driver in a second position, according to at least some embodiments of the present invention.

FIG. 6 is a perspective view of a prior art bearing race and seal driver set in a disassembled condition.

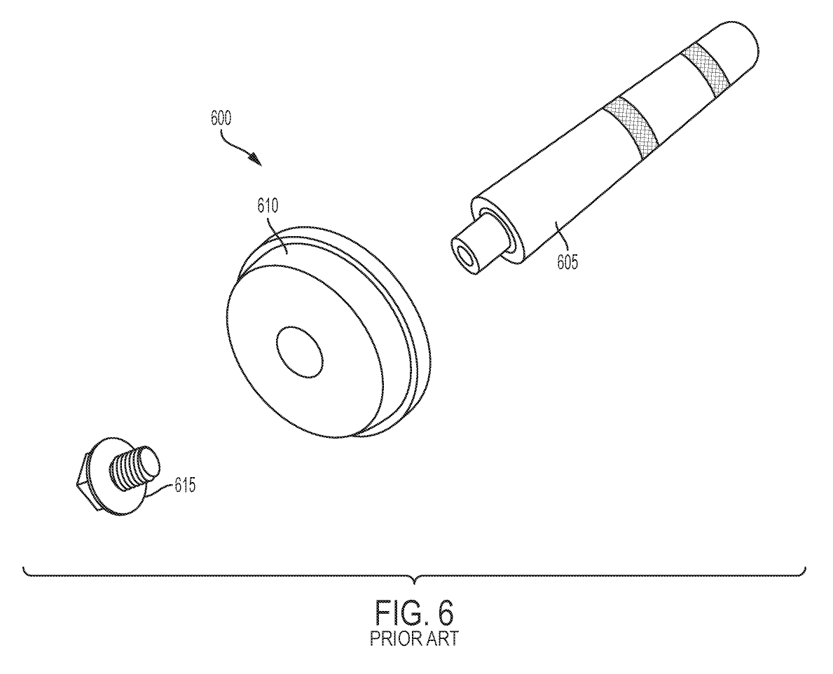

FIG. 7 is a perspective view of the prior art bearing race and seal driver set of FIG. 6, in an assembled condition.

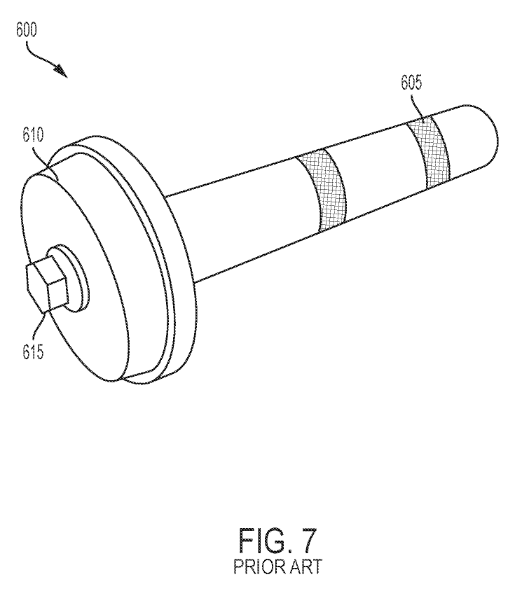

### DETAILED DESCRIPTION OF THE EMBODIMENTS

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention broadly comprises a bearing race and seal driving tool with a handle having both a grip for a user's hand and a cap that can be struck by a hammer during use. The driver can include a groove or other indent that engages with a ball detent of the handle so that the handle and driver can be quickly assembled.

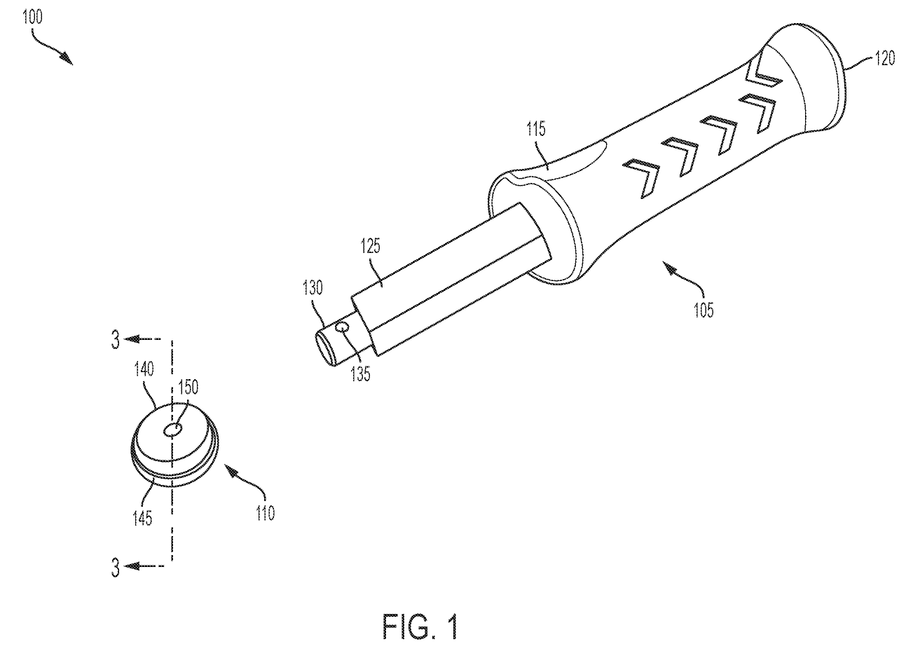

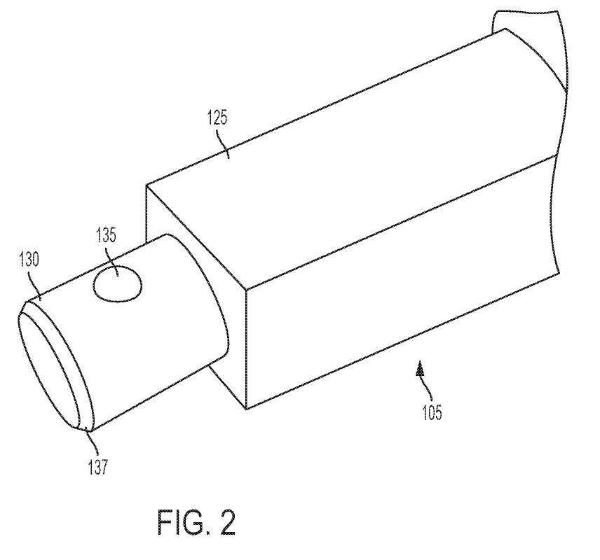

Referring to FIGS. 1-5, an embodiment of the present invention broadly comprises a tool 100 with a handle 105 and a driver disk 110. The handle 105 can include a grip 115 that is adapted to be gripped by a user's hand during use, and a cap 120 that can be struck by a hammer or other tool to install the bearing race or seal. The handle 105 can further include a rod 125 extending from the grip 115 that acts as a structural backbone of the handle 105. The rod 125 leads to a drive 130 having a spring-biased ball 135, for example a ball detent. The drive 130 can include a chamfer 137 that allows the driver disk 110 to more easily assemble onto the drive 130 into the driver disk 110.

The driver disk 110 can include a base 140 and a rim 145 circumferentially surrounding the base 140. An opening 150 can be defined through the axial center of the driver disk 110 and can include a groove 155 or other indent that can receive the ball 135 to couple the driver disk 110 to the handle 105.

The grip 115 can be any structure capable of being gripped by a user. For example, the grip 115 can be a polymer or foam sleeve that surrounds the rod 125, or can be a plastic-molded component with ridges or texture that allows a user to better grip the handle 105. The grip 115 can include an opening where the cap 120 is exposed. As compared to the grip 115, the cap 120 can be made of a more durable, high-toughness material that can absorb impact forces from a hammer or other striking tool when the tool 100 is in use. For example, the cap 120 can be made of a metal and the grip 115 can be made of polymer or foam that is more easily gripped. In some embodiments, and without limitation, the cap 120 can be an extension of the rod 125, at the axial end of the rod 125, and the grip 115 can overlay the rod 125. Also, the grip 115 can circumferentially surround the rod 125.

The drive 130 can be an extension of the rod 125 and can be of a smaller cross-sectional area, measured along a radial cut at the drive 130 and the rod 125. The drive 130 can be the connection point between the driver disk 110 and the handle 105, and accordingly, the larger cross-sectional area rod 125 braces the driver disk 110 by abutting the base of the driver disk 110 when the driver disk 110 is coupled to the handle 105. In some embodiments, the drive 130 has a length that is at least as long as the axial length of the opening 150 in the driver disk 110.

The ball 135 can be a spring-biased ball that operates in a conventional ball detent manner. For example, the ball 135 can include a spring disposed in a bore below the ball to bias the ball 135 outwardly and into engagement with the groove 155. The elastic force of the spring can maintain the engagement of the ball 135 and groove 155 to detainably couple the handle 105 to the driver disk 110. However, when the driver disk 110 needs to be removed from the handle 105, the driver disk 110 can be pulled away from the handle 105 against the elastic force of the ball 135, which can be disposed within the drive 130 and biased outward relative to the longitudinal axis of the drive 130. The handle 105 and driver disk 110 can therefore be detainably coupled together in a simple and quick manner, rather than requiring a separate fastener and additional installation steps. For example, the driver disk 110 can insert more easily onto the drive 130 due to the chamfer 137, can then engage with the ball 135 by positioning the groove 155 over the ball 135, and can then detainably couple into place for use.

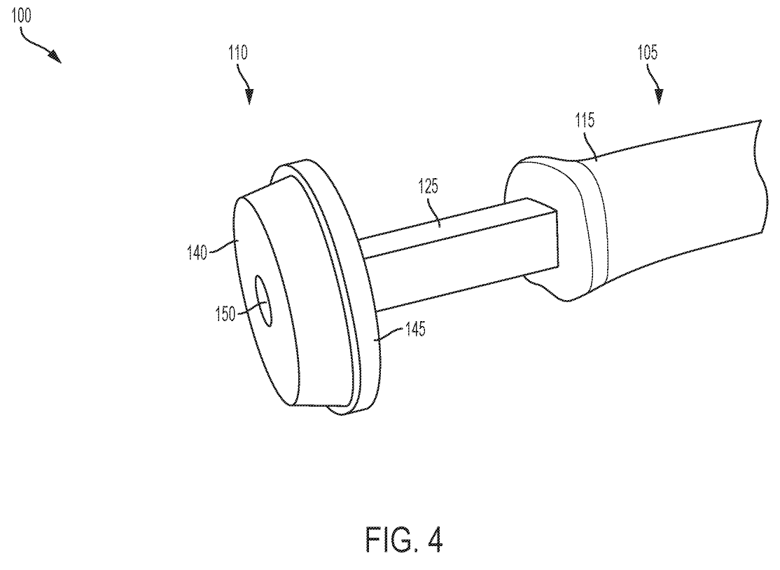

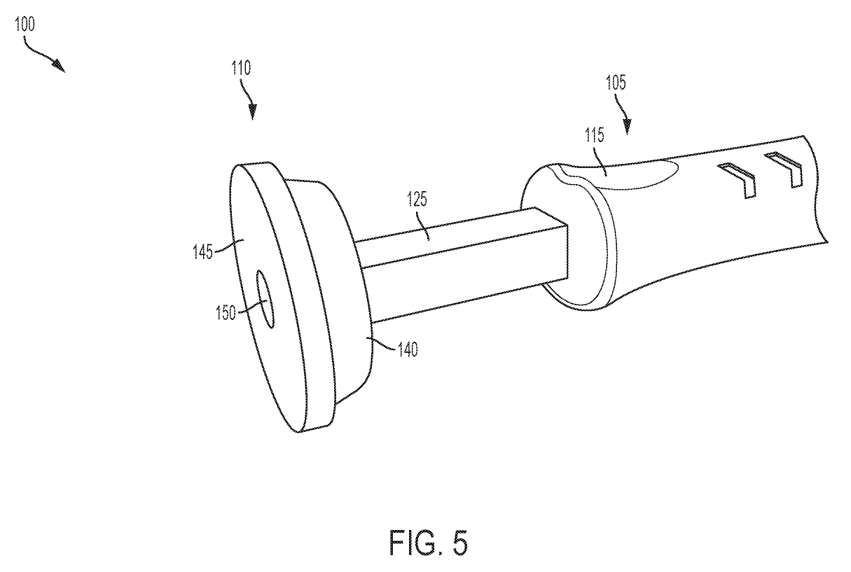

The base 140 of the driver disk 110 acts as the structural backbone of the driver disk 110. As shown, the base 140 is shaped as a disk with the opening 150 defined within its axial center. The rim 145 can surround the base 140 and provide a different radial circular component as compared to the base 140. For example, as shown in FIG. 4, the driver disk 110 can be detainably coupled to the handle 105 in such a manner to allow the base 140 to face the bearing race or seal, or the driver disk 110 can be detainably coupled to the handle 105 in such a manner to allow the rim 145 to face the bearing race or seal, as shown in FIG. 5.

The reversibility of the driver disk 110 improves the versatility of the tool 100 as a whole because it allows the driver disk 110 to be used in a first position, where the base 140 faces outward and therefore can be used to apply bearing races, or a second position, where the rim 145 faces outward to apply seals. A user can simply flip the driver disk 110 between a configuration in which the driver disk 110 is best adapted to install bearing races, to an opposite position in which the driver disk 110 is adapted to install seals, by removing the driver disk 110 from the retaining force of the ball 135, rotating the driver disk 110 by 180 degrees to flip it over, and reattaching the driver disk 110 to the handle 105.

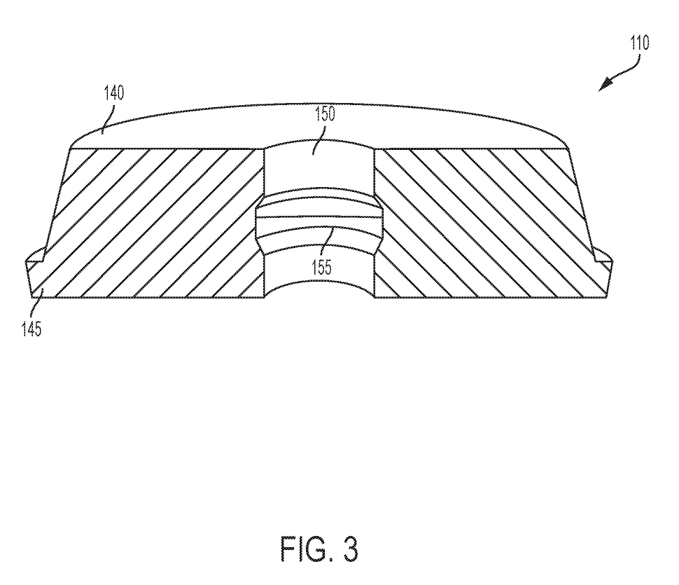

Referring to FIG. 3, the driver disk 110 includes the base 140 and rim 145, as discussed above. FIG. 3 more clearly illustrates an embodiment of the groove 155 in which the ball 135 can engage with the groove 155 during coupling of the driver disk 110 and the handle 105. For example, the ball 135 can be inserted into the groove 155 by first inserting the drive 130 into the opening 150. Prior to reaching the groove 155, the ball 135 will be depressed inwardly within the drive 130 but axially biased outwardly while the drive 130 is within the opening 150. Once the drive 130 is pushed into the opening 150 a sufficient amount, the ball 135 will bias outwardly and engage the groove 155 to detainably couple the handle 105 to the driver disk 110.

As shown, the groove 155 need not be a traditional groove, and can be any type of indent capable of receiving the ball 135 and coupling the handle 105 to the driver disk 110. For example, and without limitation, the groove 155 can be a hemispherical or other-shaped indent, and need not extend completely or even partially around the internal surface of the opening 150 in a circumferential manner.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. Also, the terms “detainably” and “releasably” are used interchangeably.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a handle including:
a grip;
a rod extending from the grip;
a drive extending from the rod; and
a ball disposed within the drive and biased outwardly relative to a longitudinal axis of the drive;
a driver disk including:
a body;
an opening defined within the body; and
a groove defined within the opening that is adapted to engage with the ball to detainably couple the handle to the driver disk.

2. The tool of claim 1, further comprising a cap disposed proximate the handle and composed of a cap material, wherein the grip is composed of a grip material, and wherein the cap material has a higher impact toughness as compared to the grip material.

3. The tool of claim 2, wherein the cap is disposed at an axial end of the handle opposite the drive.

4. The tool of claim 2, wherein the cap is an axial end of the rod.

5. The tool of claim 1, wherein the grip circumferentially surrounds the rod.

6. The tool of claim 1, wherein the drive includes a chamfer at an axial end of the drive.

7. The tool of claim 1, wherein the groove is a circumferential groove that extends around an interior surface of the opening.

8. The tool of claim 1, wherein the driver disk further includes a base and a rim circumferentially extending from the base.

9. The tool of claim 8, wherein the driver disk is disposed to face the base away from the grip when disposed on the handle in a first position, and the driver disk is disposed to face the rim away from the grip when disposed on the handle in a second position, and wherein the driver disk is removable from the handle to be positioned in either the first or second position.

10. The tool of claim 1, wherein the rod cross-sectional area is larger than the drive cross-sectional area.

11. A tool comprising:
a grip composed of a grip material;
a rod extending from the grip and having a rod cross-sectional area;
a cap disposed proximate the handle and composed of a cap material, wherein the cap material has a higher impact toughness compared to the grip material;
a drive extending from the rod and having a drive cross-sectional area less than the rod cross-sectional area;
a chamfer disposed at an axial end of the drive; and
a ball disposed within the drive and biased outward relative to the longitudinal axis of the drive;
a driver disk including:
a body;
a rim extending circumferentially from the body;
an opening defined within the body; and
a groove defined within the opening and receiving the ball to couple the handle to the driver disk.

12. The tool of claim 11, wherein the grip circumferentially surrounds the rod.

13. The tool of claim 11, wherein the driver disk is disposed to face the base away from the grip when disposed on the handle in a first position, and the driver disk is disposed to face the rim away from the grip when disposed on the handle in a second position, and wherein the driver disk is removable from the handle to be positioned in either the first or second position.

14. The tool of claim 11, wherein the cap is disposed at an axial end of the handle, opposite the drive.

15. The tool of claim 14, wherein the cap is an axial end of the rod.

16. A method of installing a bearing race comprising:
providing a handle including a grip, a rod extending from the grip, a drive extending from the rod, and a ball disposed within the drive and biased outward relative to the longitudinal axis of the drive;
providing a driver disk including a body, an opening defined within the body, and a groove defined within the opening; and
assembling the handle to the driver disk by inserting the drive into the opening, depressing the ball against a bias of the ball, and allowing the ball to engage the groove to couple the handle to the driver disk.

17. The method of claim 16, wherein the step of providing the driver disk includes providing the driver disk with a base and a rim circumferentially surrounding the base.

18. The method of claim 17, further comprising removing the driver disk from the handle, flipping the driver disk, and reassembling the driver disk to the handle by inserting the drive into the opening.

19. The method of claim 16, wherein the step of providing the handle includes providing a handle having a chamfer at an axial end of the drive, and the step of assembling includes inserting the drive into the opening by first inserting the chamfer into the opening.

20. The method of claim 16, wherein the step of providing the handle includes providing a cap at an axial end of the handle, the cap having a cap toughness greater than a grip toughness of the grip, and striking the cap.
